(19) United States
(12) Patent Application Publication
(10) Pub. No.: US 2026/0028015 A1
(43) Pub. Date: Jan. 29, 2026

(54) SYSTEM AND METHOD FOR OPERATING A HYBRID VEHICLE

(71) Applicant: Caterpillar Inc., Peoria, IL (US)

(72) Inventor: Kyle P. HEWERDINE, Chillicothe, IL (US)

(73) Assignee: Caterpillar Inc., Peoria, IL (US)

(21) Appl. No.: 18/783,986

(22) Filed: Jul. 25, 2024

(51) Int. Cl. B60W 20/30; B60K 6/36; B60W 10/06; B60W 10/196

(52) U.S. Cl. CPC B60W 20/30; B60K 6/36; B60W 10/06; B60W 10/196; B60W 2510/0638; B60W 2510/244; B60W 2530/10; B60W 2530/16; B60W 2552/15; B60Y 2200/92

(57) ABSTRACT

A system and method of operating a hybrid vehicle having a hybrid powertrain including a motor-generator unit, a battery electrically connected to the motor-generator unit, an engine, and a transmission engageably connected to the engine and the motor-generator unit, the transmission having a plurality of gears. The hybrid vehicle also includes a controller for controlling the hybrid powertrain. The controller is configured to determine a gear for the hybrid vehicle based on a retarding capability of the hybrid powertrain and a grade or slope of a terrain. The retarding capability is based on a state of charge of the battery and at least one of a weight of the hybrid vehicle or a rolling resistance of the hybrid vehicle.

### TECHNICAL FIELD

The present disclosure relates generally to hybrid vehicles, and more particularly, to a system and method for operating a hybrid vehicle.

### BACKGROUND

Heavy vehicles, such as mining, construction, and military vehicles, are often required to traverse steep slopes or grades. Under certain conditions, particularly when heading down hill, the vehicle may enter a run-away condition, in which the vehicle cannot be stopped under its own power. To help prevent such run-away conditions, many vehicles use engine braking to slow themselves, in addition to their brakes. The effects of engine braking, which may include compression release braking, often depend on the selection of an appropriate gear within the transmission, with lower gears providing greater retarding forces than higher gears. In hybrid vehicles, a motor-generator unit (“MGU”) can provide additional retarding capabilities (e.g., a retarding force), while also charging the battery. A hybrid vehicle may use a controller to determine an appropriate gear in consideration of the retarding force provided by the entire hybrid powertrain, but these controllers often make such determinations with limited inputs.

Chinese Patent Application Publication No. CN116176558A, published on May 30, 2023 (“the '558 publication”), describes an operating method for a hybrid system. The hybrid system includes an electric motor for providing a first portion of power by consuming electric energy of a battery, an engine for providing a second portion of power by consuming fuel, and a transmission for transmitting power provided by the engine. A controller is configured to carry out a function for selecting a gear based on fuel economy and drivability. The controller may include a monitoring unit for acquiring a power demand and an operating status of the hybrid powertrain, an analysis unit for determining a target gear, and a command unit for generating operating commands including shift commands for the transmission. However, the method of the '558 publication patent may fail to account for additional variables that may dynamically affect the retarding capability of the powertrain.

The system and method for operating a hybrid vehicle of the present disclosure may solve one or more of the problems set forth above and/or other problems in the art. The scope of the current disclosure, however, is defined by the attached claims, and not by the ability to solve any specific problem.

### SUMMARY

In one aspect, the disclosure relates to a hybrid vehicle, the hybrid vehicle may include a hybrid powertrain having a motor-generator unit, a battery electrically connected to the motor-generator unit, an engine, and a transmission engageably connected to the engine and the motor-generator unit, the transmission having a plurality of gears. The hybrid vehicle further may further include a controller for controlling the hybrid powertrain. The controller may be configured to determine a gear for the hybrid vehicle based on a retarding capability of the hybrid powertrain and a grade or slope of a terrain. The retarding capability may be based on a state of charge of the battery and at least one of a weight of the hybrid vehicle or a rolling resistance of the hybrid vehicle.

In one aspect, the disclosure relates to a method of operating a hybrid vehicle on a terrain. The method may include: determining, by the hybrid vehicle, a grade or slope of the terrain that the hybrid vehicle is operating on; determining, by the hybrid vehicle, a retarding capability of a hybrid powertrain within the hybrid vehicle; and determining, by the hybrid vehicle, an appropriate gear of the hybrid powertrain based on the retarding capability of the hybrid powertrain and the grade or slope of the terrain. The hybrid powertrain of the method may include a motor-generator unit, a battery electrically connected to a motor-generator unit, an engine, and a transmission engageably connected to the engine and the motor-generator unit, the transmission having a plurality of gears. The retarding capability of the hybrid powertrain may be determined based on a state of charge of the battery and at least one of a weight of the vehicle or a rolling resistance of the vehicle.

In one aspect, the disclosure relates to a controller for a hybrid vehicle. The controller may be configured to determine a grade or slope of a terrain that the hybrid vehicle is operating on, determine a retarding capability a hybrid powertrain within the hybrid vehicle, and determine an appropriate gear of the hybrid powertrain based on the retarding capability of the hybrid powertrain and the grade or slope of a terrain upon which the hybrid vehicle is operating. The hybrid vehicle may include a motor-generator unit, a battery electrically connected to the motor-generator unit, an engine and, and a transmission engageably connected to the engine and the motor-generator unit. The retarding capability may be determined based on a state of charge of the battery and at least one of a weight of the vehicle or a rolling resistance of the vehicle.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 a hybrid vehicle, according to aspects of the disclosure.

FIG. 2 is a diagram of a hybrid powertrain of the hybrid vehicle of FIG. 1.

FIG. 3 is a diagram of a control system of the hybrid vehicle of FIG. 1.

FIG. 4 provides a flowchart depicting an exemplary method for operating a vehicle having a hybrid powertrain

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value.

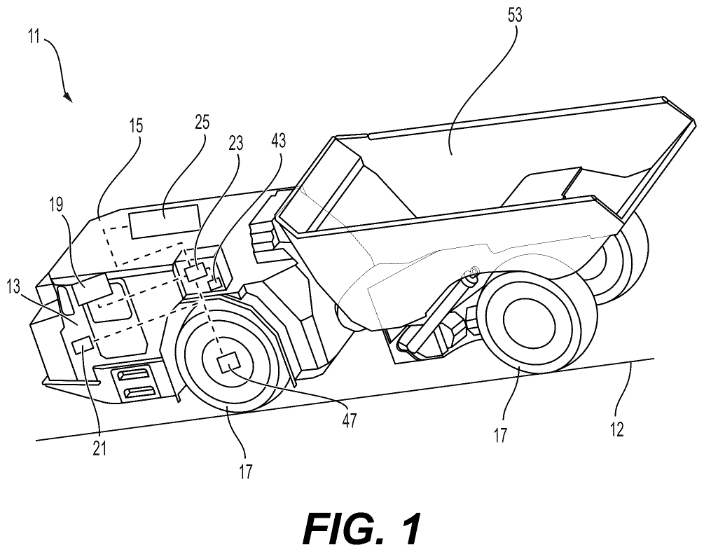

FIG. 1 depicts a hybrid vehicle 11 according to aspects of the disclosure. The hybrid vehicle 11 may operate on a terrain 12 that is sloped. The hybrid vehicle 11 may include a hybrid powertrain 25 including a battery 29, a motor-generator unit (“MGU”) 27, an engine 31, and a transmission 35 having gears 39. When loading conditions of the hybrid vehicle 11 change, the hybrid vehicle 11 may select an appropriate gear 39 based on factors including the grade or slope of the terrain 12, and the retarding capability of the hybrid powertrain. The retarding capability of the hybrid powertrain 25 may be determined based on the state of charge of the battery 29, as well as the weight of the hybrid vehicle 11, the rolling resistance of the hybrid vehicle 11, or the capability of the gears 39.

As shown in FIG. 1, the hybrid vehicle 11 may include a cab 13, a housing 15, and ground engaging elements 17. Within the cab 13, the hybrid vehicle 11 may include a user interface 19 and one or more control elements, for example, pedals 21. The user interface 19 may be a touch screen device, switches, or another appropriate interface(s) for receiving user input. The pedals 21 may include one or more of an accelerator pedal, a brake pedal, or a clutch pedal, depending on the vehicle. Within the housing 15 may be the hybrid powertrain 25, described in more detail below. The hybrid vehicle 11 may further include a controller 23 in electronic communication with the user interface 19, the pedals 21, and the hybrid powertrain 25. The hybrid vehicle 11 may further include an inertial measurement unit (“IMU”) 43 and a wheel speed sensor 47, and IMU 43 or wheel speed sensor 47 may be mounted on or near one or more ground engaging elements 17 of the hybrid vehicle 11. The IMU 43, the wheel speed sensor 47, and other sensors described below may also be in electronic communication (e.g., via one or more wired or wireless connections) with the controller 23.

FIG. 1 depicts the hybrid vehicle 11 as an articulated haul truck, for example, including a bed 53. Additionally, the ground engaging elements 17 are depicted as tires. In other examples, the hybrid vehicle 11 may be another type of large vehicle, such as a heavy duty truck, a bus, a track type vehicle, a mining vehicle, etc. Furthermore, in some examples, the ground engaging elements 17 may be another suitable vehicle propulsion system, such as one or more tracks (e.g., continuous track treads).

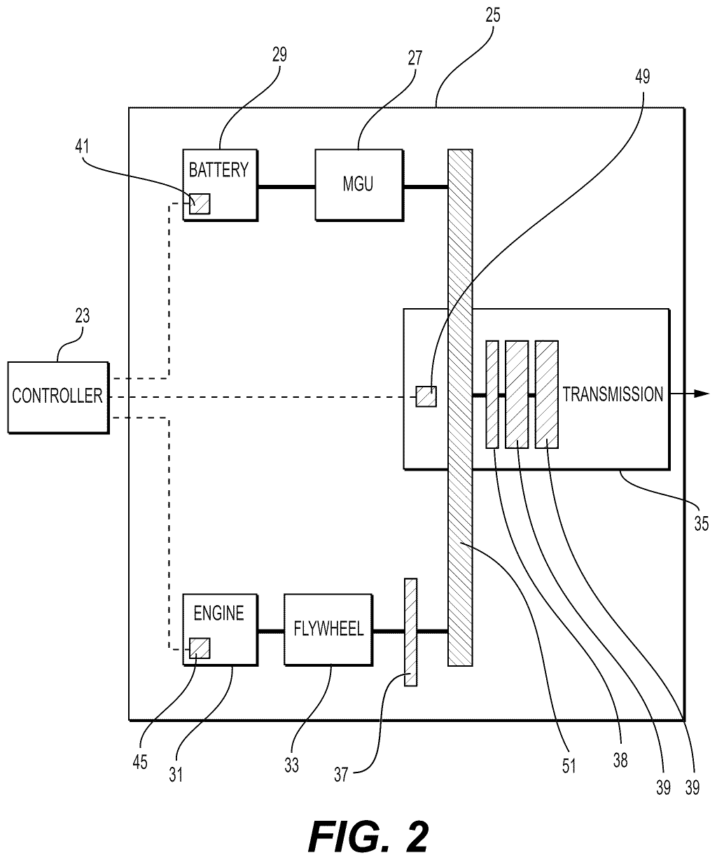

FIG. 2 is a diagram of the hybrid powertrain 25 of the hybrid vehicle of FIG. 1. The battery 29 may be electrically connected to the MGU 27, which may allow power or energy to flow between the battery 29 and the MGU 27, for example, in either direction. The flywheel 33 may be rotatably connected to the engine 31 via a crankshaft (not shown). The flywheel 33 may be engageably and rotatably connected to one or more shaft(s) 51 by a clutch 37. The shaft(s) 51 may extend between the clutch 37 and the MGU 27, and the shaft(s) 51 may connect both the engine 31 and the MGU 27 to the transmission 35.

The transmission 35 may output power received from the MGU 27, the engine 31, or both to the ground engaging elements 17 (FIG. 1). The transmission 35 may include a number of clutches 38 and gears 39. The clutches 37 may interact with the gears 39 so as select and change the gears 39 being driven by the MGU 27 or the engine 31.

The hybrid powertrain 25 may include a number of sensors, which may be in electronic communication (e.g., via wired or wireless connections) with the controller 23. For example, the battery 29 may include a state of charge sensor (“SOC sensor”) 41 connected to the controller 23, and the SOC sensor 41 may relay or otherwise transmit signals indicative of a state of charge of the battery 29 to the controller 23. The engine 31 may include an engine speed sensor 45, and the engine speed sensor 45 may relay or otherwise transmit signals indicative of a speed of the engine 31 to the controller 23. Additionally, the transmission 35 may include a transmission sensor 49, for example, within one or more portions of the transmission 35, and the transmission sensor 49 may relay or otherwise transmit signals indicative of a current selected gear 39 of the transmission 35 to the controller 23. In these aspects, the transmission sensor 49 may monitor and/or calculate the current selected gear 39 of the transmission 35.

Both the engine 31 and the MGU 27 may contribute to the retarding capability of the hybrid powertrain 25, and therefore the hybrid vehicle 11. In the engine 31, the retarding force may be provided by engine braking and/or compression release braking (both of which are referred to generally as “engine braking”). In the MGU 27, the retarding force may be provided through regenerative braking, wherein the MGU 27 behaves as a generator driven by the shaft(s) 51, and generates electricity to charge the battery 29. The retarding capability of both the engine 31 and the MGU 27 may be variable, and the variation may be controlled by the controller 23.

The amount of retarding force provided by each of the engine 31 and the MGU 27 may change depending on either or both of the gear or the speed of the hybrid vehicle 11. When a lower gear is selected, the gear ratio within the transmission 35 may cause the shaft(s) 51 to spin faster, which may amplify the retarding effects provided by the engine 31 and the MGU 27 through gear braking and regenerative braking respectively.

The amount of retarding force provided by the MGU 27 may also depend on the state of charge of the battery 29. As the MGU 27 may charge the battery 29 during regenerative braking, the use of regenerative braking must be limited so as not to overcharge the battery 29. Therefore, the use of the MGU 27 to slow the vehicle may be reduced as the battery 29 charges, and, therefore, the retarding capability of the hybrid vehicle 11 and the hybrid powertrain 25 decreases as the state of charge of the battery 29 increases. However, operation of the hybrid vehicle 11 may deplete the state of charge of the battery 29, which may allow for increased amounts of regenerative braking via the MGU 27. As such, the retarding capability of the hybrid vehicle 11 and the hybrid powertrain 25 may increase as the state of charge of the battery decreases.

Other internal forces within the hybrid powertrain 25 may also contribute to the retarding forces working to slow, limit, or maintain the speed of the hybrid vehicle 11. These forces may include, but are not limited to, the weight of the hybrid vehicle 11, the rolling resistance of the hybrid vehicle 11, and the orientation of the vehicle due to the slope of the terrain 12.

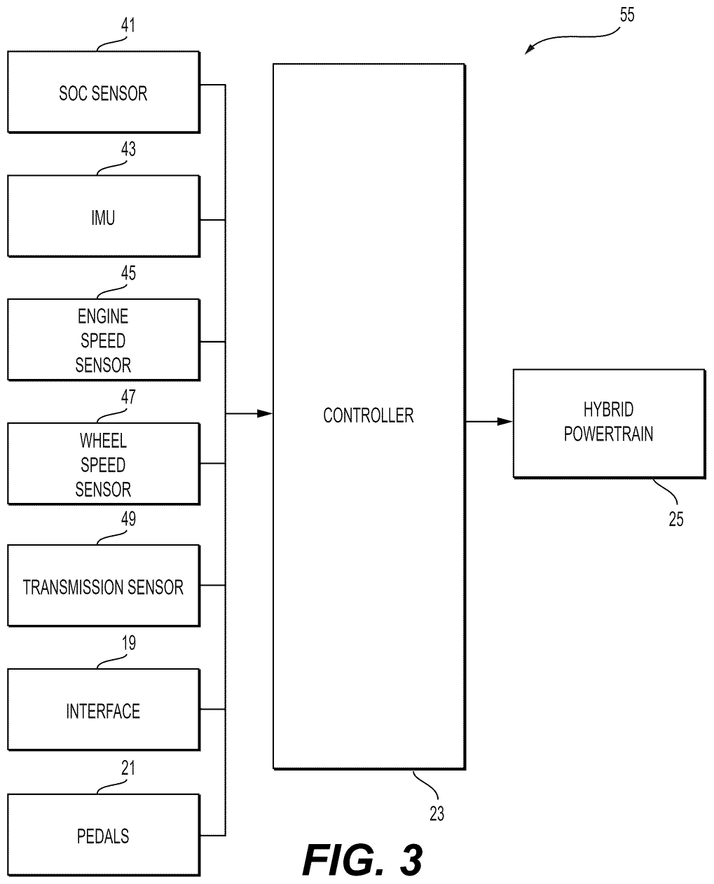

FIG. 3 is a diagram of control system 55 of the hybrid vehicle of FIG. 1. The control system 55 may include the controller 23, the SOC sensor 41, the IMU 43, the transmission sensor 49, the wheel speed sensor 47, the engine speed sensor 45, the user interface 19, the pedals 21, the hybrid powertrain 25, and one or more other sensors and components.

The controller 23 may be a control module that controls one or more aspects of the hybrid vehicle 11, including for example, the hybrid powertrain 25. The controller 23 may be a single controller configured to control the hybrid vehicle 11. If desired, the controller 23 may be a single controller dedicated to one or more aspects of the hybrid vehicle 11 or combustion engine 200. As used herein the term “controller,” while singular, includes both a single controller and multiple controllers that operate with the hybrid vehicle 11. Thus, the controller 23 may be implemented as a plurality of distributed control modules in communication with each other. The controller 23 may be enabled, via programming, to receive inputs (e.g., from SOC sensor 41) generate outputs (e.g., a gear 39 of the transmission 35).

The controller 23 may embody a single microprocessor or multiple microprocessors that receive inputs or generate outputs. The controller 23 may include a memory, as well as a secondary storage device, a processor, such as a central processing unit, or any other means or devices for accomplishing a task consistent with this disclosure. The memory or secondary storage device associated with the controller 23 may store data and software to allow the controller 23 to perform its functions, including the functions described herein. In particular, the memory for the controller 23 may store instructions that, when executed by one or more processors, enable these processors to perform one or more of the functions described herein. Numerous commercially available microprocessors can be configured to perform the functions of the controller 23. Various other known circuits may be associated with the controller 23, including signal-conditioning circuitry, communication circuitry, and other appropriate circuitry.

As shown in FIG. 3, the controller 23 may receive inputs from one or more of the controller 23, the SOC sensor 41, the IMU 43, the engine speed sensor 45, the wheel speed sensor 47, the transmission sensor 49, the user interface 19, or the pedals 21. The inputs may include the value measured by the sensors, for example, the state of charge of the battery 29 as measured by the SOC sensor 41, the slope or grade of the terrain 12 as determined by the IMU 43, the speed of the engine 31 as measured by the engine speed sensor 45, the speed of the ground engaging elements 17 as measured by the wheel speed sensor 47, the current selected gear 39 as determined by transmission sensor 49. The inputs may also include values input by a user, such as representative values of selections made by a user at the user interface 19, or the value of the amount a user depresses one of the pedals 21. The controller 23 may also send one or more outputs to the transmission 35. The outputs may include, among other things, instructions to the transmission 35 on when to shift gears 39.

From the inputs, the controller 23 may determine the desired speed of the hybrid vehicle 11, the slope of the terrain 12 on which the hybrid vehicle 11 is operating, the state of charge of the battery 29, and the amount of retarding force available for given gear 39 within the transmission 35. The desired speed may be determined from any of: the amount one or more of the pedals 21 is depressed; an input to the user interface 19; preset values within the controller 23; or another input to the controller 23. The slope may be determined from measurements taken by, or computations carried out by, the IMU 43. In other examples, the slope may be determined from prerecorded topography data in conjunction with the GPS coordinates. Other sensors and means may also be used to measure or determine the slope of the terrain on which the hybrid vehicle operates.

The retarding capability of the hybrid powertrain 25 may be determined by the ability of the engine 31 and MGU 27 to dissipate energy in each gear by engine braking or regenerative braking, respectively, as well as the known safe operating limits of the engine 31 (for example, the maximum rotations per minute, “RPM” of the engine 31). The retarding capability may further be determined by the state of charge of the battery 29, as it affects the amount of retarding force that can be supplied by the MGU 27 through regenerative braking, as explained above.

In determining the retarding capability of the hybrid powertrain 25, the controller 23 may also consider at least one of the weight of the hybrid vehicle 11 or the rolling resistance of the hybrid vehicle 11. The weight and/or rolling resistance of the hybrid vehicle 11 may be dynamically determined by one or more sensors within the hybrid vehicle 11. The weight and/or rolling resistance of the hybrid vehicle 11 may also be static values stored in the controller 23, or may be one or more values input at the user interface 19.

The retarding capability of the hybrid powertrain 25 may be variable, such that the controller 23 determines the appropriate gear based on a range of values for the retarding capability of the hybrid powertrain 25. The controller may alter the working conditions of the engine 31 or the MGU 27 to increase or reduce the retarding force that each can provide. Further, the retarding capability of both the engine 31 and the MGU 27 may change based on, for example, changes to the weight of the hybrid vehicle 11 or changes in the slope of the terrain 12.

From the inputs, the controller 23 may select a gear 39 based on the amount of charge that can be provided to the battery 29 while limiting the hybrid vehicle 11 to the desired speed. For example, when the state of charge of the battery 29 is such that the battery 29 can accept further charge, the controller 23 may select the highest gear 39 that allows the hybrid vehicle 11 to maintain a desired speed of the hybrid vehicle 11 while providing charge to the battery 29 through regenerative braking via the MGU 27. When the state of charge of the battery 29 is such that the battery 29 can no longer accept charge, the controller may select a lower gear that allows more energy to be dissipated through engine braking via the engine 31 while limiting or omitting any regenerative braking via the MGU 27.

In selecting the gear 39, if the battery 29 is at a predetermined state of charge, the controller 23 may select a lower gear 39 such that greater retarding force may be provided by the engine 31 and a lesser amount of retarding force may be provided by the MGU 27. For example if the battery 29 is more than 80% full, the controller may downshift to avoid overcharging the battery 29. Additionally, if the total amount of retarding force provided by both the engine 31 and the MGU 27 is insufficient to slow or maintain the hybrid vehicle 11 at a desired speed, the controller 23 may select successively lower gears until the combination of available retarding forces from both the engine 31 and the MGU 27 is sufficient to retain the hybrid vehicle 11 at a desired speed.

A user may enable and disable the automatic selection of the gears 39 from, for example, the user interface 19, allowing the user to select a desired gear 39 at any time. In some examples, the controller 23 may relay a suggested gear to the user interface 19, and the user may manually select a gear from the user interface 19 or by another means, such as a shifter (not pictured).

### INDUSTRIAL APPLICABILITY

The disclosed aspects of the present disclosure may help to allow for safe operation of hybrid vehicles, particularly heavy vehicles such as mining vehicles, construction vehicles, and military vehicles.

The method of operation allows the controller 23 to select a gear based on a broader number of inputs, including the dynamically changing retarding capability of the hybrid powertrain 25 and the state of charge of the battery 29. The controller 23 may progressively lower the gear 39 to avoid unsafe operating conditions or damage to the hybrid powertrain. The lowering of the gear 39 may help to decrease, limit, or maintain the speed of the hybrid vehicle 11 while on sloped terrain. The user may also choose to disable the automatic selection of gears 39 by the controller 23, allowing operation of the hybrid vehicle 11 at a speed or gear desired by the operator.

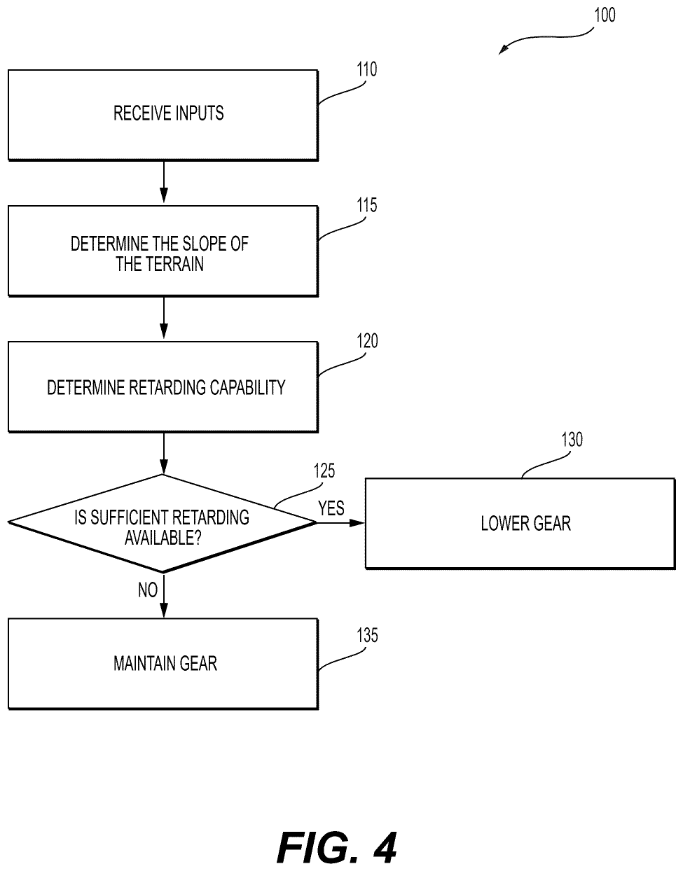

FIG. 4 provides a flowchart depicting an exemplary method for operating a hybrid vehicle 11 having a hybrid powertrain 25. At a step 105, the controller may receive inputs from one or more of the SOC sensor 41, the IMU 43, the transmission sensor 49, the wheel speed sensor 47, the engine speed sensor 45, the transmission sensor 49, the user interface 19, and the pedals 21. The inputs may include the state of charge of the battery 29, the slope or grade of the terrain 12, the speed of the engine 31, the speed of the ground engaging elements 17, or the current selected gear 39. At step 115, the controller may determine the slope of the terrain based on, for example, the inputs from the IMU 43. From the slope, the controller 23 may then determine the retarding force necessary to maintain or slow the hybrid vehicle to a desired speed. At step 120, the controller 23 may determine the retarding capability of the hybrid powertrain 25 for the current gear. In determining the retarding capability of the hybrid powertrain 25, the controller 23 may consider the state of charge of the battery 29 and whether regenerative braking may be used to slow the hybrid vehicle 11. If the state of charge of the battery 29 is low, the controller 23 may enable or include regenerative braking via the MGU 27 in the determination of the retarding capability. At step 125, the controller may determine whether the hybrid powertrain 25 may provide sufficient retarding capability at the current gear to keep the hybrid vehicle 11 at a desired speed for the current slope of the terrain 12. If sufficient retarding capability is available, then at step 135, the controller may maintain the current selected gear 39. If sufficient retarding capability is not available at the current gear 39, then at step 130, the controller 23 may lower the gear 39, increasing the retarding capability of the hybrid powertrain 25. If the retarding capability of the new lower gear is still insufficient, the controller 23 may continue to lower the gear 39 until the retarding capability is sufficient. The method may help to progressively lower the gear 39 to avoid unsafe operating conditions or damage to the hybrid powertrain. The lowering of the gear 39 may help to decrease, limit, or maintain the speed of the hybrid vehicle 11 while on sloped terrain 12.

It will be apparent to those skilled in the art that various modifications and variations can be made to the disclosed system, vehicle, and method of operation without departing from the scope of the disclosure. Other embodiments of the system, vehicle, and method of operation will be apparent to those skilled in the art from consideration of the specification and practice of the system, vehicle, and method of operation disclosed herein. It is intended that the specification and examples be considered as exemplary only, with a true scope of the disclosure being indicated by the following claims and their equivalents.

What is claimed is:

1. A hybrid vehicle, the hybrid vehicle comprising:
a hybrid powertrain including:
a motor-generator unit;
a battery electrically connected to the motor-generator unit;
an engine; and
a transmission engageably connected to the engine and the motor-generator unit, the transmission having a plurality of gears; and
a controller for controlling the hybrid powertrain,
wherein the controller is configured to determine a gear for the hybrid vehicle based on a retarding capability of the hybrid powertrain and a grade or slope of a terrain,
wherein the retarding capability is based on a state of charge of the battery and at least one of a weight of the hybrid vehicle or a rolling resistance of the hybrid vehicle.

2. The hybrid vehicle of claim 1, wherein the retarding capability of the hybrid powertrain includes a retarding capability of the engine due to engine braking and a retarding capability of the motor-generator unit due to regenerative braking.

3. The hybrid vehicle of claim 1, wherein the battery is charged due to the retarding capability of the hybrid powertrain.

4. The hybrid vehicle of claim 1, wherein the controller is configured to lower a gear as the state of charge of the battery increases.

5. The hybrid vehicle of claim 1, further including a user input, the user input is configured to allow a user to select a gear of the transmission.

6. The hybrid vehicle of claim 1, further comprising an engine speed sensor.

7. The hybrid vehicle of claim 1, further comprising an inertial measurement unit.

8. The hybrid vehicle of claim 1, further comprising a state of charge sensor.

9. A method of operating a hybrid vehicle on a terrain, the method comprising:
determining, by the hybrid vehicle, a grade or slope of the terrain that the hybrid vehicle is operating on;
determining, by the hybrid vehicle, a retarding capability of a hybrid powertrain within the hybrid vehicle, wherein the retarding capability of the hybrid powertrain is determined based on a state of charge of the battery and at least one of a weight of the vehicle or a rolling resistance of the vehicle, the hybrid powertrain including:
a motor-generator unit,
a battery electrically connected to a motor-generator unit,
an engine, and
a transmission engageably connected to the engine and the motor-generator unit, the transmission having a plurality of gears; and
determining, by the hybrid vehicle, an appropriate gear of the hybrid powertrain based on the retarding capability of the hybrid powertrain and the grade or slope of the terrain.

10. The method of claim 9, wherein the retarding capability of the hybrid powertrain is further determined based on a retarding capability of the engine due to engine braking and a retarding capability of the motor-generator unit due to regenerative braking.

11. The method of claim 9, wherein the battery is charged due to the retarding capability of the hybrid powertrain via the motor-generator unit.

12. The method of claim 9, wherein the gear is lowered as the state of charge of the battery increases.

13. The method of claim 9, wherein the retarding capability decreases as a state of charge of the battery increases.

14. The method of claim 9, wherein the retarding capability increases as a state of charge of the battery decreases.

15. The method of claim 9, wherein the gear of the hybrid vehicle is selected by a controller.

16. The method of claim 9, wherein an initial gear of the hybrid vehicle is selected by an input from an operator.

17. A controller for a hybrid vehicle, the controller configured to:
determine a grade or slope of a terrain that the hybrid vehicle is operating on;
determine a retarding capability a hybrid powertrain within the hybrid vehicle, wherein the retarding capability is determined based on a state of charge of the battery and at least one of a weight of the vehicle or a rolling resistance of the vehicle, the hybrid vehicle including:
a motor-generator unit,
a battery electrically connected to the motor-generator unit,
an engine and, and
a transmission engageably connected to the engine and the motor-generator unit; and
determine an appropriate gear of the hybrid powertrain based on the retarding capability of the hybrid powertrain and the grade or slope of a terrain upon which the hybrid vehicle is operating.

18. The controller of claim 17, wherein the controller determines the retarding capability of hybrid powertrain by determining a retarding capability of the engine due to engine braking and a retarding capability of the motor-generator unit due to regenerative braking.

19. The controller of claim 17, wherein the controller is further configured to determine a new gear of the hybrid powertrain as the retarding capability of the hybrid powertrain changes.

20. The controller of claim 19, wherein the controller is further configured to lower the gear of the hybrid powertrain as the state of charge of the battery increases.
